(19) United States
(12) Patent Application Publication
(10) Pub. No.: US 2024/0126225 A1
(43) Pub. Date: Apr. 18, 2024

(54) METHOD AND DEVICE FOR MACHINE MONITORING, AND COMPUTER PROGRAM PRODUCT FOR MACHINE MONITORING

(71) Applicant: PANDIA GMBH, Glarus (CH)

(72) Inventors: Mauro NART, Glarus (CH); Jonas NART, Glarus (CH)

(21) Appl. No.: 18/276,324

(22) PCT Filed: Feb. 4, 2022
(86) PCT No.: PCT/EP2022/052670

§ 371 Date: Aug. 8, 2023

(30) Foreign Application Priority Data
Feb. 10, 2021 (DE) 10 2021 103 102.8

(51) Int. Cl. G05B 15/02

(52) U.S. Cl. CPC G05B 15/02

(57) ABSTRACT

This version will replace all prior versions in the application: A method and a device for machine monitoring and a computer program product for machine monitoring. The image data captured with the aid of at least one camera and any additionally collected measurement data are time-limited using the image data captured with the aid of a trigger camera and evaluated for the presence of a trigger event such that only the relevant time range of the image data and, if applicable, measurement data has to be stored and analyzed. Time synchronization of different (image) data sources, a color filter function, and/or a master-frame comparison for recognizing faults can be implemented.

The invention relates to a device for machine monitoring in terms of a device for capturing and evaluating sensor data, in particular image data, for monitoring machines and facilities and processes executed using these machines or facilities.

In addition, the invention relates to a method for machine monitoring in terms of a method for capturing and evaluating sensor data, in particular image data, for monitoring machines and facilities and processes executed using these machines or facilities.

Furthermore, the invention relates to a computer program product for machine monitoring, which, installed on suitable hardware, is used for capturing and evaluating sensor data, in particular image data, for monitoring machines and facilities and processes executed using these machines or facilities.

Production and processing machines or facilities are presently generally highly automated. Complex and fast mechanical processes run on facilities which are often large and confusing. Malfunctions of such machines or facilities can occur in particular during start-up, after refitting, or due to changing production parameters, which can result in flawed products or damage to the machines or facilities themselves.

Complex and poorly comprehensible machine processes are often accordingly involved in malfunctions of machines or facilities or processes executed using these machines or facilities. In addition, processes or individual process steps can be too fast or run too fast to be able to perceive them with the human eye.

Therefore, automated devices and methods are used for machine monitoring, which create the necessary conditions for effective monitoring using technical means.

Corresponding devices and methods are already known, which include cameras for monitoring machines and facilities or the processes executed thereby, so that monitoring can take place with the aid of the image data captured by the cameras. This monitoring is used, for example, to identify flawed products produced using the machines or facilities. The evaluation of the images captured using the cameras or video sequences consisting of multiple images permits conclusions about, for example, incorrectly set process parameters and other error sources in the operation of the machines and facilities and processes executed using these machines or facilities.

A large amount of data accumulates during the continuous monitoring of machines, facilities, and the processes executed using these machines or facilities, which have to be stored and evaluated to identify and eliminate errors. In particular in the case of high-resolution image data, which are recorded using fast cameras, large storage devices are required for storing these amounts of data. Malfunctions often occur only sporadically, however, so that initially large amounts of data have to be evaluated in order to find the relevant time range in the image data at all.

Furthermore, the data captured using known devices and methods for machine monitoring are usually only locally available, so that experts have to evaluate the data on location to be able to identify and eliminate the errors.

The devices and methods for machine monitoring known from the prior art accordingly have diverse disadvantages, which the present invention is to eliminate.

One object of the invention is therefore to provide an improved device for machine monitoring.

This object is achieved according to the invention by a device for machine monitoring as claimed in claim 1.

A further object of the invention is to provide a device for machine monitoring which reduces the amount of data to be evaluated in an automated manner to at least one relevant time range.

This object is achieved according to the invention by a device for machine monitoring as claimed in claim 1.

A further object of the invention is to provide an improved method for machine monitoring.

This object is achieved according to the invention by a method for machine monitoring as claimed in claim 6.

A further object of the invention is to provide a computer program product for machine monitoring, which solves the above-mentioned problems.

This object is achieved according to the invention by a computer program product for machine monitoring as claimed in claim 14.

The features disclosed hereinafter of a device for machine monitoring are part of the invention both individually and in all executable combinations.

A device according to the invention for machine monitoring includes at least one camera and a control unit and an evaluation unit or at least one control and evaluation unit.

The at least one camera is used to capture image data. The image detail which can be captured by the camera is adapted here to the machine or facility to be monitored or the process executed using the respective machine or facility. Targeted monitoring of a specific machine area is thus implementable.

The at least one camera preferably has an image resolution of at least 1280×720 pixels and an image capture rate of approximately 25 FPS (frames per second) to at least 240 FPS. However, high-speed cameras having image capture rates of approximately 1000 FPS are also usable.

In one preferred embodiment, the at least one camera has an image resolution of at least 1280×720 pixels and an image capture rate of at least 30 FPS. A higher temporal resolution enables the evaluation of processes running faster.

In a further preferred embodiment of the invention, the at least one camera has an image resolution of at least 1920×1080 pixels. A higher resolution enables a more detailed evaluation of the captured images, but requires more capacities for evaluating and storing the images.

It is advantageous to use an image capture rate which is just sufficient to resolve the relevant processes adequately, in order to thus limit the amount of data to be stored and analyzed to that required.

In one advantageous embodiment, a device according to the invention for machine monitoring includes a plurality of cameras. For example, a device according to the invention for machine monitoring includes 2, 3, or 4 cameras.

The use of multiple cameras enables the simultaneous monitoring of different machine areas. Process steps running locally at various locations of a machine can thus be monitored simultaneously and examined for possible causalities.

The use of 2, 3, or 4 cameras has proven to be optimum in practice for most applications.

The at least one camera is connected to the control unit for exchanging data and preferably for activating the at least one camera.

This connection is implemented with the aid of a network module of the device for machine monitoring.

The network module is particularly preferably designed to establish a wireless connection to the at least one camera.

In one embodiment of the invention, the at least one camera is connected with the aid of a WLAN connection to the control unit of the device for machine monitoring.

Furthermore, the device for machine monitoring includes at least one storage unit for storing the captured data. For example, the storage unit is designed as a hard drive.

In embodiments of the invention, the evaluation unit, the control unit, and the at least one storage unit are integrated in a common housing, while the at least one camera is positionable independently thereof on the machine or facility to be monitored. The network module is connected as a separate module to the control unit and the evaluation unit.

In other embodiments of the invention, the evaluation unit, the control unit, the at least one storage unit, and the network module are integrated in a common housing, while the at least one camera is positionable independently thereof on the machine or facility to be monitored.

In further embodiments of the invention, it includes a first and a second evaluation unit, wherein at least one of the evaluation units is not integrated with the control unit in a common housing.

The components integrated in a common housing form the central unit and the at least one camera and possibly additional sensors form the satellites. The central unit comprises at least the evaluation unit, the control unit, or the control and evaluation unit and the at least one storage unit.

The device according to the invention for machine monitoring preferably includes at least one display, via which the acquired data can be output to a user. An evaluation of the data can thus take place immediately on location.

For example, the display is integrated in the central unit of a device according to the invention for machine monitoring.

If the device for machine monitoring does not have an integrated display, in embodiments of the invention, at least one external display is connectable to the device for machine monitoring or is connectable thereto via a local network.

However, it is also possible according to the invention not to provide a display on the device for machine monitoring itself, so that an evaluation of the image data by experts is enabled exclusively “remotely” after the upload of the image data to the Internet.

At least one camera of a device according to the invention for machine monitoring is designed as a trigger camera, using which the recording of image data can be triggered.

The use of a trigger camera enables the focusing of the analysis of the acquired data on a relevant time range, so that only a part of the overall acquired amount of data has to be evaluated.

The trigger camera is connected to the evaluation unit here in such a way that the image data captured with the aid of the trigger camera can be evaluated continuously for the occurrence of a predetermined trigger event.

In embodiments having a first and a second evaluation unit, the trigger camera is connected to the first evaluation unit in such a way that the image data captured with the aid of the trigger camera can be evaluated continuously for the occurrence of a predetermined trigger event.

The predetermined trigger event is set here on the basis of the machine or facility to be monitored or the process executed using the respective machine or facility.

As soon as the trigger camera captures a trigger event, which is identified as such by the evaluation unit, the image data resulting from the recording carried out continuously using the at least one camera are reducible to a relevant time window. The image data of this time window are then storable for the evaluation and analysis with the aid of the storage unit.

This further evaluation and analysis can be carried out in embodiments having two evaluation units with the aid of the second evaluation unit.

In advantageous embodiments of the invention, the time window is settable for all cameras and/or individually for each of the cameras. This contributes to the most effective possible limiting of the amounts of data in particular with regard to the arrangement of the cameras on the machine or facility in dependence on the process executed using the machine or facility. If, for example, a camera is arranged in the temporal process sequence before the trigger camera, a different time window is thus relevant than if the camera is arranged in the temporal process sequence after the trigger camera.

The absolute length of the time window and/or the position of the time window is preferably configurable in dependence on the trigger event for this purpose.

In the simplest case, with the detection of the trigger event, a fixed time window is defined around the trigger event for the image data to be stored.

For example, this is implemented by video sequences of predetermined length, wherein those video sequences are discarded which lie completely before the time window lying around the trigger event, and in addition to the video sequence containing the trigger event and, depending on the embodiment of the invention, video sequences recorded in parallel using further cameras, a defined number of video sequences following the video sequence containing the trigger event can possibly be incorporated.

In embodiments of the invention, the device for machine monitoring is designed for identifying a trigger event by identifying a movement or identifying a standstill.

For this purpose, the evaluation unit is designed in preferred embodiments of the invention for identifying differences in successive images. Further details in this regard are disclosed by the method according to the invention for machine monitoring.

The use of multiple cameras requires a time synchronization of the image data for a reliable evaluation and analysis of dependencies of the events recorded using the respective cameras. The detection of the trigger event with the aid of the trigger camera also requires a temporal classification of the trigger event to the image data of the respective camera for the time restriction of the image data recorded using the at least one further camera.

A delay of the image data transmitted from the various cameras to the evaluation unit results in particular from deviating data transmission times from the respective camera to the evaluation unit or the transmission of a control command from the control unit to the respective camera.

In advantageous embodiments of the invention, the device for machine monitoring is therefore designed for synchronizing the image data captured using the cameras.

In particular if a WLAN connection to the at least one camera of the device for machine monitoring is implemented with the aid of the network module, a time synchronization is necessary since a synchronization is not supported by the WLAN protocol itself.

Details on an advantageous implementation of the synchronization are disclosed in the course of the method according to the invention for machine monitoring.

In embodiments according to the invention, a device for machine monitoring is designed for capturing and evaluating the data of further sensors (e.g., temperature, vibration, acceleration sensors, or thermal imaging cameras). The analysis of the influence of measured variables, which possibly cannot be captured or can only be captured to a restricted extent using conventional cameras, on a malfunction of a machine or facility is thus enabled.

In embodiments of the invention, the device according to the invention for machine monitoring includes separate sensors for this purpose, which can be placed in the area of the machine or facility to be monitored. In other embodiments, the device according to the invention for machine monitoring includes an interface for connecting the machine or facility to be monitored itself, so that the data from sensors installed in the machine or facility itself can also be evaluated with the aid of the device for machine monitoring. A combination of the above-mentioned alternatives is also possible, so that a device according to the invention for machine monitoring is designed in embodiments for evaluating the image data captured with the aid of the at least one camera and/or the measurement data of further sensors of the device for machine monitoring and/or the measurement data from sensors installed in the machine or facility itself.

In advantageous embodiments of the invention, the device for machine monitoring includes an Internet module for establishing a connection to the Internet. A remote access to the data captured with the aid of the device for machine monitoring is thus preferably enabled, so that external experts can be integrated for evaluating and analyzing the data, without them having to be on location.

The remote access to the captured data can either take place here by connecting the device according to the invention for machine monitoring or by uploading the captured image data into the Internet, for example into the cloud.

In embodiments of the invention, the network module and the Internet module are integrated in a common network and Internet module.

In embodiments having two evaluation units, the second evaluation unit can be arranged independently in location relative to the remainder of the device and can be connected thereto via an Internet connection.

The at least one camera is equipped in one preferred embodiment of the invention with a camera mount, by which the camera is fastenable on the machine or facility or in the area of the machine or facility and can be oriented on the desired capture area.

In one particularly preferred embodiment of the invention, the camera mount includes a base detachably connectable to a carrier, on which a flexibly deformable leg is fastened. The flexibly deformable leg has sufficient rigidity here to hold a set position. This is implementable, for example, by a leg formed from multiple appropriately rigid ball joints. At the end of the leg, the camera mount includes a receptacle device for the camera.

The base of the camera mount is advantageously magnetic, so that the camera mount is magnetically connectable to a corresponding carrier. This is often provided in the area of the machines or facilities to be monitored.

The method steps disclosed hereinafter of a method according to the invention for machine monitoring are part of the invention both individually and in all executable combinations.

A method according to the invention for machine monitoring comprises the camera-based monitoring of a machine or at least one area of a machine using at least one camera, wherein the image data captured with the aid of the at least one camera are evaluated.

In preferred embodiments of the method according to the invention, image data from an area and/or viewing angle of the machine or facility to be monitored are captured and evaluated from each camera simultaneously using 2, 3, or 4 cameras.

In further advantageous embodiments of the invention, further sensor data are additionally captured and evaluated. Such further sensor data can be, for example, the temperature, vibrations, or accelerations captured using corresponding sensors or images captured with the aid of thermal imaging cameras.

Since errors in production processes captured with the aid of the method according to the invention only sporadically occur in many cases and large amounts of data accumulate during continuous capturing and storage of the image data of the at least one camera and/or further sensors, which require a large amount of storage space and the detailed evaluation of which is complex, one camera is configured as a trigger camera according to the invention.

The trigger camera continuously captures the image data in the area of view of the camera. These image data are progressively evaluated for the occurrence of a trigger event. As soon as a trigger event is detected, the video captured using the at least one camera is restricted (or shortened) to a predefined time window. The amount of data to be stored and evaluated is thus significantly reduced.

This windowing is also applied for other possibly captured sensor data in corresponding embodiments of the invention.

In one embodiment of the invention, video sequences of a predetermined length, such as 50 seconds, for example, are continuously captured using the at least one camera. These video sequences are then evaluated in succession for the occurrence of a trigger event, while the next video sequence is already recorded using the at least one camera at the same time.

In one preferred embodiment of the method according to the invention, videos are recorded in parallel using 2, 3, or 4 cameras, while one of the cameras is configured as a trigger camera.

The windowing taking place upon the occurrence of a trigger event in the video of the trigger camera and the evaluation of the videos of the further cameras or further sensors taking place later require a time synchronization of the videos and possibly the further sensor measurement data in relation to one another, since the time relationship of the time-restricted videos or sensor measurement data otherwise cannot be ensured.

Such a time synchronization is required in particular if the at least one camera and at least one further camera and/or a further sensor are connected via a network, wherein the transmission delays of the individual data transmission paths (i.e., from a control and evaluation unit to the respective camera or the respective sensor and back) can differ from one another. This is the case, for example, if cameras or sensors are connected via a WLAN connection. In addition, current WLAN protocols do not offer separate synchronization mechanisms.

In one advantageous embodiment of a method according to the invention for machine monitoring, a time synchronization of the captured image data of various cameras and possibly the additionally captured sensor data is therefore carried out.

In one embodiment of the invention, the synchronization of the image data and/or sensor measurement data is carried out in that a time query is sent to the respective cameras or sensors. Therefore, a separate local clock (real-time clock—RTC) has to run in each camera or sensor. At the time of the time query to the respective camera or the respective sensor, the time of the local clock is read out there and transmitted via the network to the central control and evaluation unit or to the network module. As soon as the local time of the respective camera or the respective sensor is received by the control and evaluation unit or the network module, it reads out the time of its local clock and determines the difference of the times.

This difference is then assumed as the channel delay. The channel delay of a channel is preferably determined by averaging over multiple measurements.

By way of the measurement of the channel delays of the various channels, in embodiments of the invention, the relative delay from channel to channel is determined, so that the data collected with the aid of the cameras or the at least one camera and at least one further sensor can be time synchronized.

In one preferred embodiment of the invention, after the detection of a trigger event, the synchronization of the data received via the various channels, and the subsequent windowing of the data, the video recordings and possibly the additional sensor data are immediately provided in an analysis mode.

Depending on the embodiment of the method, the data are output visually prepared on a display to a user of the method on location and/or made available for analysis via the Internet.

In the analysis mode, in one preferred embodiment of the method according to the invention, a synchronous display of the video recordings of all cameras and possibly the measurement data of additional sensors takes place for the parallel evaluation.

This display is implemented in embodiments of the invention by a display divided in accordance with the number of the cameras and/or sensors, so that the respective data are visible adjacent to one another.

In embodiments of the invention, an evaluation of the image data or the further sensor measurement data frame by frame (or measured value by measured value) and/or in slow motion and/or with a zoom function is enabled in the analysis mode.

Furthermore, a color filter is applicable to image data in preferred embodiments of the invention, so that an analysis can be facilitated by hiding colors and/or filtering out a single color. Such a color filter can also be used in embodiments of the invention in the evaluation of the image material with regard to the presence of a trigger event.

If the color filter is applied, the image data captured with the aid of at least one camera (3) are processed with the aid of a color filter in such a way that the image data set processed with the aid of the color filter only has a defined limited color range.

In advantageous embodiments of the invention, videos provided for storage are subjected to video rendering or video compression automatically or upon a manual input, so that a smaller file size is implemented for an export of these video sequences (for example as an MPEG file). The synchronized video sequences of the individual cameras can thus also be played back and evaluated as a rendered video file on any device having corresponding routine playback software and independently of the special software on a device according to the invention for machine monitoring or the implementation of a method according to the invention for machine monitoring in software.

In one particularly preferred embodiment of the method according to the invention, a remote access to and/or cloud sharing of the captured and at least temporarily stored data is implemented. For this purpose, an Internet-based access from the outside to the data and/or an upload of the data onto a web server is implemented, from which the data are retrievable for analysis and evaluation.

This enables the integration of external experts for tracking down errors in the operation of the machine or facility and for eliminating these errors.

In preferred embodiments of the invention, automatic messaging of one or more defined users upon the identification of a trigger event is implemented, for example, via email, SMS, or push message.

Persons responsible for the error identification and elimination can thus begin immediately with the evaluation of the collected data without having to wait for an unnecessary time.

In a further advantageous embodiment of the method according to the invention, a visual and/or an acoustic identification of errors or a quality control by a master frame comparison is implemented.

In this case, a sequence of the corresponding sensor measurement data, preferably a video sequence, is recorded in the process running without error or a partial process. It is assumed here that a periodic procedure runs in the observed process or partial process.

This is the case, for example, if the manufactured and ideally identical products run in succession through the image area in the corresponding area. A master frame is defined from this sequence. This master frame is either an image in which a specific quality feature or a suspected error can be identified well, or an acoustic spectrum at a specific time.

The capture of the sensor measurement data takes place according to the set sampling rate at a series of data capture times.

In the running process or partial process, each period of the sensor measurement data is then analyzed for the presence of the master frame thus defined, in that the sensor measurement data at the individual data capture times are automatically compared to the master frame. If a sufficient correspondence of the captured sensor measurement data with the master frame is established in a period at at least one data capture time, this is thus viewed as error-free. Vice versa, a period is viewed as subject to errors if it was not possible to establish a sufficient correspondence with the master frame.

In one preferred embodiment of a method according to the invention for machine monitoring, a device according to the invention is used for machine monitoring.

A computer program product according to the invention, installed on suitable hardware, is used for capturing and evaluating sensor data for monitoring machines and facilities and processes executed using these machines or facilities.

A computer program product according to the invention for machine monitoring comprises commands which, upon the execution by at least one computer, prompt it to carry out a method according to the invention for machine monitoring.

In preferred embodiments of the invention, the computer program product includes at least two software modules, wherein at least one first software module of the computer program product is designed for installation and execution on at least one camera and at least one second software module of the computer program product is designed for installation and execution on a central unit and/or a network module.

In addition to the use for monitoring machines and facilities, the monitoring of other things and sequences is also possible using the invention. For example, a use in the area of sports, for example, for identifying specific situations, is also considered.

Exemplary embodiments of the invention are schematically shown in the figures described hereinafter. In the figures:

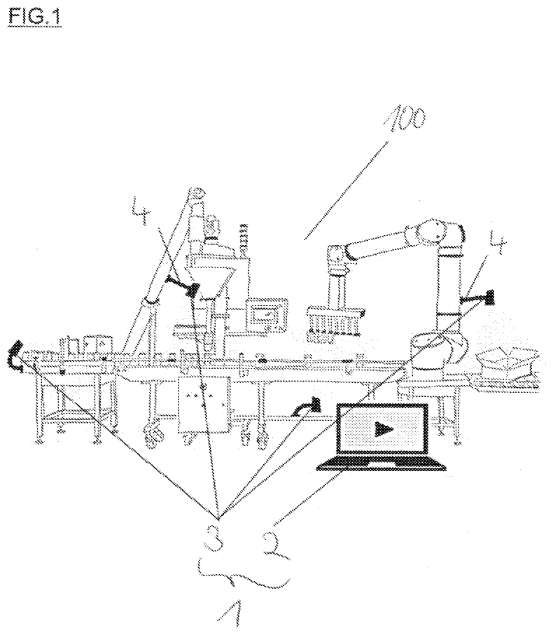

FIG. 1: shows a schematic illustration of a device according to the invention for machine monitoring in the area of a machine,

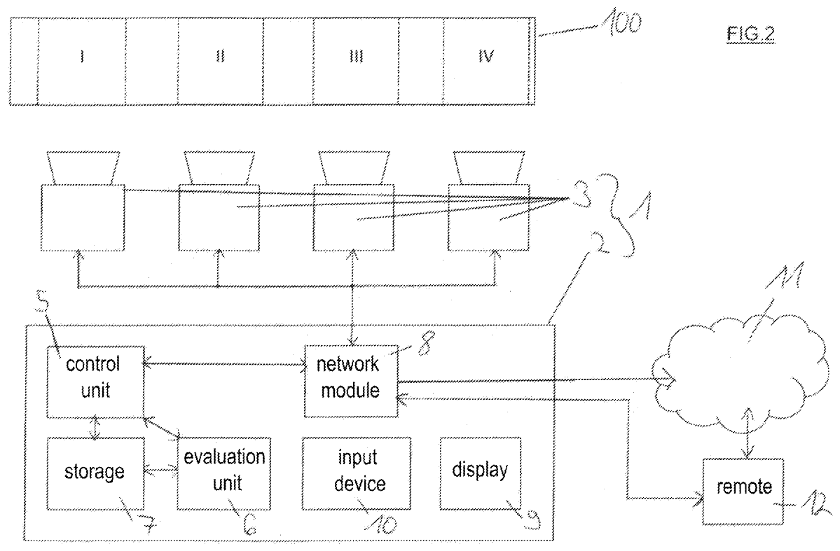

FIG. 2: shows a block diagram of an embodiment according to the invention of a device for machine monitoring,

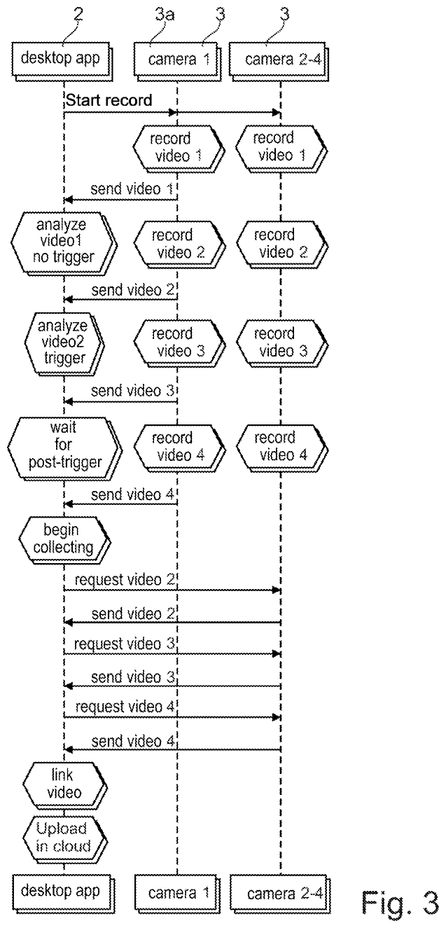

FIG. 3: shows a schematic flow chart of the implementation of a trigger camera in a device according to the invention and in a method according to the invention for machine monitoring,

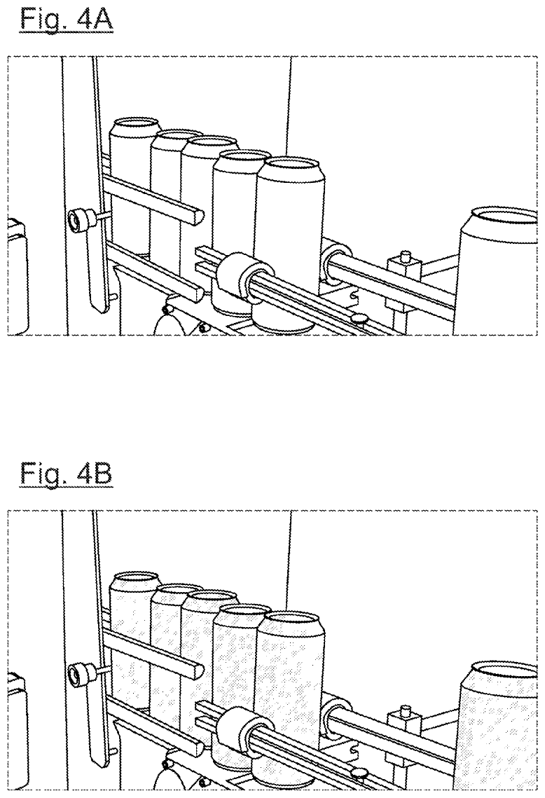

FIG. 4A: shows a schematic illustration of a single recorded image from an area of a monitored machine,

FIG. 4B: shows a schematic illustration of the image evaluation to identify the presence of a trigger event,

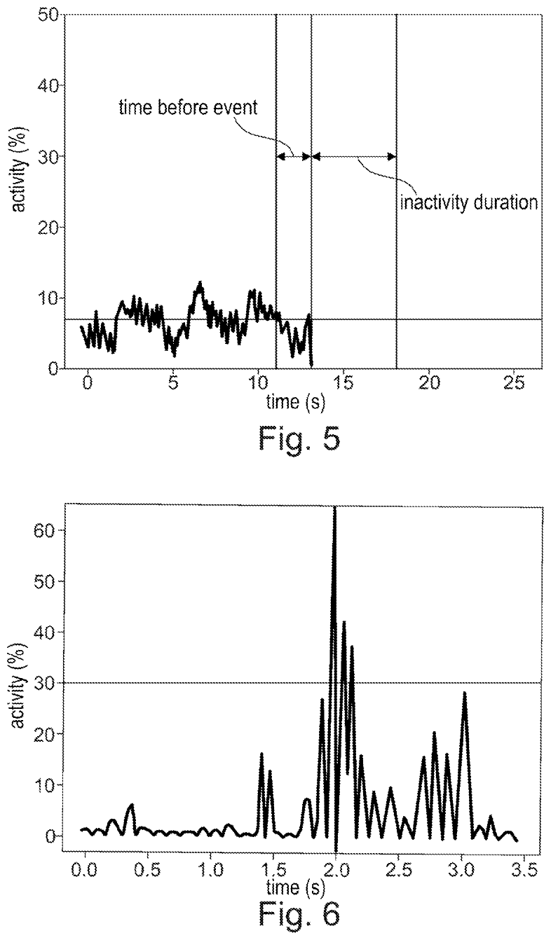

FIG. 5: shows a diagram for the image evaluation to identify the presence of a trigger event,

FIG. 6: shows a further diagram for the image evaluation to identify the presence of a trigger event,

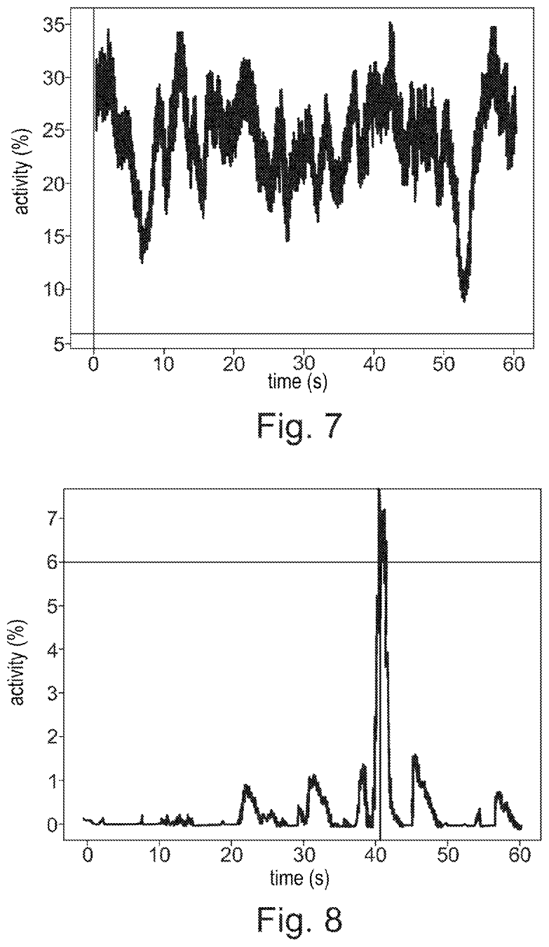

FIG. 7: shows a diagram for the image evaluation without color filter,

FIG. 8: shows a diagram for the image evaluation with color filter,

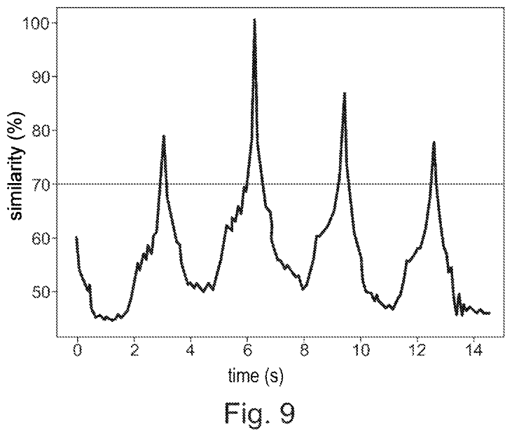

FIG. 9: shows a diagram for the image evaluation for a master frame comparison, and

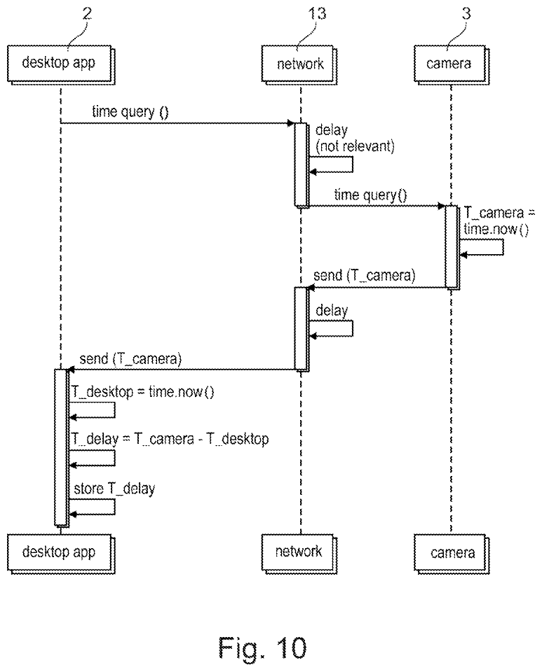

FIG. 10: shows a schematic flow chart for the synchronization of the various channels of a device according to the invention or a method according to the invention.

FIG. 1 schematically shows a device according to the invention for machine monitoring (1) in the area of a machine (100). The device for machine monitoring (1) includes a central unit (2) and four cameras (3), which are fastened with the aid of camera mounts (4) on the machine (100) to be monitored. Due to the orientation of the cameras (4), the capture areas thereof are directed onto specific areas of the machine (100), so that these can each be monitored using one camera (3).

FIG. 2 shows a schematic block diagram of an embodiment of a device according to the invention for machine monitoring (1). This includes four cameras (3), which are each oriented on a specific area (I, II, III, IV) of the machine (100). The central unit (2) of the device for machine monitoring (1) includes a control unit (5), an evaluation unit (6), a storage unit (7), a network module (8), a display (9), and an input device (10).

The input device (10) is used to capture user inputs at the central unit (2) of the device for machine monitoring (1) and the display (9) is used to output image and/or measurement data to at least one user of the device (1).

The central unit (2) is connected to the cameras (3) with the aid of the network module (8) designed as a network and Internet module. These connections are preferably embodied as WLAN connections. Furthermore, the image data captured with the aid of the cameras (3) and evaluated and processed in the central unit (2) can be uploaded with the aid of the network module (8) via an Internet connection from the central unit (2) onto a web server in the cloud (11) and/or a remote access to the image data on the central unit (2) of the device for machine monitoring (1) for at least one remote access station (12) is enabled via an Internet connection.

FIG. 3 schematically shows the configuration of a camera (3) as a trigger camera (3a) in an embodiment according to the invention of a device for machine monitoring (1) and a method for machine monitoring. The video sequences are each of equal length, for example 50 seconds.

With the aid of the central unit (2) of the device for machine monitoring (1), a command for starting the recording is sent to all cameras (3) (from the control unit (5) via the network module (8)). The cameras (3) thereupon each record a first video sequence (video 1). After the completion of the recording of the video sequences, they are sent by the trigger camera (3a) to the central unit (2). The video recorded using the trigger camera (3a) is evaluated for the presence of a trigger event. Since no trigger event is detected in the present example, the remaining videos of the first video sequences are discarded or not retrieved from the central unit (2). After the completion of the recording of the first video sequences (video 1), the cameras (3) each immediately begin with the recording of a further video sequence (video 2), so that the evaluation of the video 1 of the trigger camera (3a) in the central unit (2) takes place at the same time. After completion of the recording of the second video sequence (video 2), the trigger camera (3) sends the video sequence (video 2) to the central unit (2), which evaluates the video for the presence of a trigger event. The cameras (3) each start immediately after the completion of the recording of the second video sequence with the recording of a third video sequence (video 3). Since a trigger event was now detected in video 2 of the trigger camera (3a), the third video sequences (video 3) of the cameras (3) are relevant for the evaluation and analysis.

In the illustrated example, a time window longer than a video sequence is to be evaluated after the occurrence of the trigger. A post-trigger time is therefore defined, which corresponds here to a predetermined time, which has to run before the video sequences of the cameras (3) are retrieved. While the central unit (2) waits for the passage of the post-trigger time, the cameras (3) record the next video sequence (video 4).

After the passage of the post-trigger time, the remaining video sequences relevant for the evaluation are then retrieved from the cameras (3). Since the trigger camera (3a) has transmitted each video sequence immediately after completion of the recording to the central unit (2), only the video sequences of the other cameras (3) have to be retrieved. Upon the sending of a corresponding command, the video sequences video 3 and video 4 are transmitted from the remaining cameras (3) to the central unit (2).

In the central unit (2), the video sequences of the cameras (3) are joined together and combined in a data packet.

The data packet contains the individual video sequences of the cameras as individual files and/or the video rendered from the individual synchronized video sequences of the cameras.

The data packet is subsequently uploaded via an Internet connection into the cloud, so that it can be evaluated by experts independently of location.

Alternatively and/or additionally, the output of the video sequences directly at the central device (2) and/or the remote access to the data packet from at least one remote access station is also possible.

In other embodiments of the invention, the trigger is implemented by the occurrence of a further event captured with the aid of the trigger camera and/or a state change captured with the aid of another sensor.

The detection of the trigger event is carried out in embodiments of the invention by the identification of a movement or a standstill. For example, the standstill of a machine part or of products conveyed with the aid of the machine (100) can imply a disturbance. A movement, for example by a product identified as flawed by other mechanisms, which is ejected from the process, can also imply such a disturbance. In addition, other events, such as the lighting up of a (warning) light or the change of a number or another display on a machine operating or monitoring module, are also suitable trigger events in the meaning of the present invention.

The detection of a movement or standstill is carried out in embodiments of the invention by a calculation of the differences between successive images (frames) of a video sequence.

FIG. 4A shows such a frame of a recorded video sequence. FIG. 4B shows the graphic representation of the difference calculation of the individual pixels of two successive frames. In this case, a white pixel means no change and a black pixel means a change by 100%. Corresponding gray scales are assigned to the differences lying in between.

In one embodiment of the invention, the frames of a video sequence are extracted for the difference calculation and converted into grayscale images. Each pixel has a value between 0 (black) and 255 (white) here. Each frame of the video sequence is compared to the chronologically successive frame, wherein a structural similarity index of the two frames is calculated. This similarity index has a value between 0.0 and 1.0, wherein 1.0 means an identity of the images and 0.0 means a complete dissimilarity of the images.

In one preferred embodiment of the invention, the method described in “Wang, Z., Bovik, A. C., Sheikh, H. R., & Simoncelli, E. P. (2004). Image quality assessment: From error visibility to structural similarity. IEEE Transactions on Image Processing, 13, 600-612” is used here.

In one embodiment of the invention, the activity level, which is between 0% and 100%, is determined from the inverse of the structural similarity index. The activity level is 0% with identical images and is 100% with completely different images here. An activity level of 9.03% is calculated from the grayscale image shown in FIG. 4B.

If the stopping of a monitored process is now to be used as a trigger event, a threshold value is defined in dependence on the process to be monitored and the activity level to be expected in the running process. If the activity level falls below this threshold value and the activity level remains below this threshold value for a predefined time, the presence of a process stop is thus identified as a trigger event.

In one embodiment of the invention, the threshold value for identifying a process stop is defined at an activity level of 7%.

FIG. 5 shows a graphic representation of the evaluation of the activity level of a video sequence. At a time t at approximately 13 seconds, the activity level falls below 7%, so that a trigger event is detected. After the trigger event, the activity level is at 0% for longer than a predetermined time (for example 5 seconds), i.e., the monitored process has stopped (inactive phase).

FIG. 6 shows a graphic representation of the evaluation of the activity level of a video sequence, wherein the start of a movement is to be detected as a trigger event here, however. For this purpose, a corresponding threshold value of the activity level is defined, upon the exceeding of which the trigger event is identified.

In the illustrated example, the threshold value is at an activity level of 30%. At the time t at approximately 20 seconds, the presence of the trigger event is identified.

The threshold value for identifying a movement as a trigger event is preferably also adapted to the activity levels to be expected in the process to be monitored.

The color filter of the present invention is explained more precisely on the basis of FIGS. 7 and 8. In corresponding embodiments of the invention, the color filter functionality permits focusing on a specific color, in particular for the evaluation of the video sequences of the trigger camera with regard to the presence of a trigger event.

Each color is assigned an RGB color value here (for example red value: 0x89, green value: 0x17, and blue value: 0x1f for a specific red tone). A tolerance range is now defined around this RGB color value for the color filter, in which a detected color still corresponds to the defined color of the color filter. In one embodiment of the invention, the tolerance range is in a distance of 30 around the RGB value of the defined color. In this example, the red value can extend from 0x64 to 0xa0, value ranges of the green value and the blue value apply accordingly in dependence on the other color values in the tolerance range.

The color filter is used in particular to identify more complex events by focusing the image evaluation on a relevant color range.

FIG. 7 shows the activity level of a video sequence over time. A continuously varying and usually high activity level is identifiable over the entire video sequence. FIG. 8 shows the activity level of the same video sequence with activated color filter. With respect to the color defined in the color filter, only a minor activity level is identifiable over almost the entire duration of the video sequence. A strong increase of the activity above the threshold value of 6% defined here can only be established in the range at just over 40 seconds.

Color changes of (warning) lights of a machine or facility to be monitored can also be identified easily by the color filter.

A similarity diagram of a video sequence is plotted over time in FIG. 9. This is the functionality of the master frame comparison here, in which each frame of a video sequence is compared to a predefined master frame.

The master frame comparison is suitable in cyclic processes for identifying the successful sequence of a process or of errors in these processes.

A video sequence of a filling machine for bottles underlies the illustrated example, wherein a bottle is provided with a label in each case in the monitored camera area. The master frame is defined as an image having correctly labeled bottle. It may now be established in each cycle by the master frame comparison whether the labeling of the bottle was carried out successfully, or whether an error is present in the process.

FIG. 9 shows a video sequence having four complete process cycles. High similarity values of the evaluated frames with the master frame are established between 3 and 4 seconds, 6 and 7 seconds, 9 and 10 seconds, and approximately at 13 seconds. The similarity values are each above the threshold value of the similarity defined here of 70%, so that a successful completion of the cycle is detected in each case.

FIG. 10 shows a schematic sequence of the synchronizing in a device according to the invention for machine monitoring (1) or in a method according to the invention for machine monitoring.

The central unit (2) sends a command to query the local time via the transmission channel (13) to a camera (3). The camera (3) reads out the time of the local clock and sends it via the transmission channel (13) to the central unit (2). The transmission of the read-out time is delayed by the transmission delay (delay) here. As soon as the central unit (2) has received the time of the clock of the camera (3), the central unit (2) reads out its own local clock and determines the difference of its own time from the time read out by the camera (2). This difference is stored as the delay of the transmission channel (13). This channel delay includes the delay of the transmission channel (13) in the network itself and, which is more important in this application, the time difference of the local clocks of the camera (3) and the central unit (2).

Since these clocks, in particular the local clocks of various cameras (3) here, are not synchronized with one another, the clocks—read out at the same time—can (and will) output different values. These local times are transmitted with the recorded video sequences as the timestamp, so that the “same” times in the video sequences of various cameras (3) were not recorded at the actual same time.

Due to the comparison of the channel delay of the various channels in relation to one another, the data sent from the respective cameras or sensors to the central unit (2) can be synchronized in time, however.

One assumption which is made here is that the transmission delay of the various channels is approximately equal, or that they only differ from one another insignificantly.

A time change of the transmission delay of the channels themselves and in relation to one another can be taken into consideration by the repetition of the time measurements and the calculation of the differences.

In one preferred embodiment of the invention, multiple, for example 10, time measurements are performed in immediate succession one after another and the differences are calculated. The standard deviation is determined from the series of the difference values of a sequence and checked as to whether it is below a specific threshold value (for example 20 ms). If this condition is met, the mean value of the differences of the sequence is stored as the delay.

1-15. (canceled)

16. A device for machine monitoring, comprising: at least one camera for capturing image data in the area of a machine; a control unit for activating components of the device; an evaluation unit for evaluating the image data captured by the at least one camera; a storage unit for storing and/or temporarily storing the image data captured by the at least one camera; and a network module for connecting the at least one camera at least to the control unit and the evaluation unit, wherein the at least one camera is a trigger camera, so that storage and/or evaluation of the image data captured using the at least one camera is limited to a relevant time range in dependence on detection of a trigger event, wherein the at least one camera is des configured to continuously record video sequences of a predetermined length, wherein the video sequences are transmittable to the control unit and the evaluation unit by the network module so that the video sequences of the trigger camera or evaluated for presence of a trigger event, so that upon a presence of the trigger event in a video sequence of the trigger camera, a predefined number of video sequences of the at least one camera is retrieved therefrom and made available for evaluation.

17. The device for machine monitoring according to claim 16, wherein the control unit, the evaluation unit, and the storage unit are arranged in a central unit that is connected by the network module to the at least one camera.

18. The device for machine monitoring according to claim 16, wherein the evaluation unit includes a color filter that is applicable to the image data captured by the at least one camera so that a processed set of image data that only has a defined limited color range is generated from the captured image data for evaluation.

19. The device for machine monitoring according to claim 16, wherein the at least one camera includes at least two cameras, wherein the image data captured using the at least two cameras is time synchronized with one another.

20. The device for machine monitoring according to claim 16, further comprising an Internet module via which the device is connectable to the Internet so that the captured image data is uploadable onto a web server in the cloud and/or remote access to the image data from a remote access station is enabled.

21. A method for machine monitoring, comprising the steps of: monitoring a machine or facility using at least one camera; recording image data of an area of the machine or facility using the at least one camera, wherein the at least one camera is configured as a trigger camera, wherein the trigger camera continuously records the image data; evaluating the image data for presence of a defined trigger event; and storing the image data of the at least one camera for evaluation and/or immediately making the image data available in a time-limited manner upon detection of the trigger event in a predetermined manner, wherein the at least one camera continuously records video sequences of a predetermined length, the video sequences recorded using the trigger camera are continuously evaluated for the presence of the trigger event, and the time limiting of the image data captured by the at least one camera upon the presence of the trigger event in a video sequence captured by the trigger camera is implemented by retrieval and storage of only a restricted predefined number of video sequences captured by the at least one camera.

22. The method for machine monitoring according to claim 21, including processing the image data captured by the at least one camera with a color filter so that and image data set processed by the color filter only has a defined limited color range.

23. The method for machine monitoring according to claim 21, including continuously capturing the image data with at least two cameras and synchronizing the image data captured by the at least two cameras.

24. The method for machine monitoring according to claim 23, wherein the at least two cameras and a central unit or a network module each include a local clock, the method including providing the image data captured using the at least two cameras with a timestamp of the respective local clock, wherein time synchronization of the image data of the at least two cameras includes retrieving local times of the at least two cameras, determining a difference of the local times of the at least two cameras from a local time of the central unit or the network module and determining a difference of the local times of the cameras from differences of the local times of one camera in each case and the central unit or the network module, and chronologically shifting the image data captured by the cameras in relation to one another in conjunction with the respective timestamp in accordance with the difference of the local times.

25. The method for machine monitoring according to claim 21, further including carrying out a visual and/or acoustic identification of errors or a quality control in a cyclic partial process or process monitored using the method by a master frame comparison, wherein a sequence of sensor measurement data corresponding to a cycle of the cyclic partial process or process is recorded, a master frame is defined from the sequence, and subsequently the sensor measurement data captured in each cycle of the partial process or process at each data capture time are compared to the master frame and wherein a cycle is assumed to be free of errors if a sufficient correspondence with the master frame is established in at least one data capture time and wherein the cycle is otherwise assumed to be subject to errors.

26. The method for machine monitoring according to claim 25, wherein the sufficient correspondence of the sensor measured values to the master frame at a data capture time is carried out by a determination of a similarity value of the sensor measured values to the master frame and a comparison of the similarity value to a predefined threshold value, wherein a sufficient similarity exists if the similarity value is above the threshold value.

27. The method for machine monitoring according to claim 21, wherein the image data captured upon the detection of the trigger event by the at least one camera and selected are uploaded as individual video sequences or rendered to form a single video in a data packet onto a web server in the cloud and/or an Internet-based remote access to these data is provided.

28. The method for machine monitoring according to claim 21, including using a device for machine monitoring that comprises: at least one camera for capturing image data in the area of a machine; a control unit for activating components of the device; an evaluation unit for evaluating the image data captured by the at least one camera; a storage unit for storing and/or temporarily storing the image data captured by the at least one camera; and a network module for connecting the at least one camera at least to the control unit and the evaluation unit, wherein the at least one camera is a trigger camera, so that storage and/or evaluation of the image data captured using the at least one camera is limited to a relevant time range in dependence on detection of a trigger event, wherein the at least one camera is des configured to continuously record video sequences of a predetermined length, wherein the video sequences are transmittable to the control unit and the evaluation unit by the network module so that the video sequences of the trigger camera or evaluated for presence of a trigger event, so that upon a presence of the trigger event in a video sequence of the trigger camera, a predefined number of video sequences of the at least one camera is retrieved therefrom and made available for evaluation.

29. A computer program product for machine monitoring, comprising program commands which, upon the execution on a computer, prompt carrying out the method for machine monitoring according to claim 21.

30. The computer program product for machine monitoring according to claim 29, comprising at least two software modules, including at least one first software module designed for installation and execution on at least one camera and at least one second software module designed for installation and execution on a central unit and/or a network module.
